(19) United States
(12) Patent Application Publication
(10) Pub. No.: US 2019/0028353 A1
(43) Pub. Date: Jan. 24, 2019

(54) DEVICE, INFORMATION PROCESSING SYSTEM, AND METHOD FOR CONTROLLING DEVICE

(71) Applicant: Akira Nagamori, Kanagawa (JP)

(72) Inventor: Akira Nagamori, Kanagawa (JP)

(73) Assignee: Ricoh Company, Ltd., Tokyo (JP)

(21) Appl. No.: 16/034,741

(22) Filed: Jul. 13, 2018

(30) Foreign Application Priority Data
Jul. 21, 2017 (JP) 2017-141817

(51) Int. Cl. H04L 12/24; H04L 29/08

(52) U.S. Cl. CPC H04L 41/12; H04L 67/12

(57) ABSTRACT

A device, an information processing system, and a method for controlling an interactive operation of the device. The device is connected to at least one other device via a network and includes circuitry configured to transmit interaction information related to interactive operation of a local device to the at least one other device via the network, receive interaction information related to interactive operation of the at least one other device via the network, store a rule that associates the interactive operation of the at least one other device with the interactive operation of the local device to be executed by the local device, and control the interactive operation of the local device based on the stored rule. The information processing system includes at least one device including the device and the at least one other devices.

### CROSS-REFERENCE TO RELATED APPLICATIONS

This patent application is based on and claims priority pursuant to 35 U.S.C. § 119(a) to Japanese Patent Application No. 2017-141817, filed on Jul. 21, 2017, in the Japan Patent Office, the entire disclosure of which is hereby incorporated by reference herein.

### BACKGROUND

### Technical Field

The present disclosure relates to a device, an information processing system, and a method for controlling an interactive operation of the device.

### Background Art

Currently, many devices including personal computers (PCs) are connected via a network such as the Internet. Further, not only the Internet communications but also network services called clouds, web services, and Application Service Providers (ASP) are expanding. The Internet of Things (IoT) is also known, which connects things including devices other than the personal computers to the Internet.

With application of the IoT communication network, not only computers and computer networks but also everyday things can be readable, recognizable, position-identifiable, addressable and controllable.

### SUMMARY

Embodiments of the present disclosure described herein provide a device, an information processing system, and a method for controlling an interactive operation of the device. The device is connected to at least one other device via a network and includes circuitry configured to transmit interaction information related to interactive operation of a local device to the at least one other device via the network, receive interaction information related to interactive operation of the at least one other device via the network, store a first rule that associates the interactive operation of the at least one other device with the interactive operation of the local device to be executed by the local device, and control the interactive operation of the local device based on the stored first rule. The information processing system includes at least one device including the device and the at least one other device. The method includes receiving interaction information related to interactive operation of the at least one other device via the network, storing a first rule which associates the interactive operation of the at least one other device with the interactive operation of the local device to be executed by the local device, and controlling the device to execute the interactive operation based on the stored first rule.

### BRIEF DESCRIPTION OF THE DRAWINGS

A more complete appreciation of the disclosure and many of the attendant advantages and features thereof can be readily obtained and understood from the following detailed description with reference to the accompanying drawings.

FIG. 1 is a block diagram of an information processing system according to an embodiment of the present disclosure.

FIG. 2 is a block diagram illustrating a hardware configuration of a multifunctional peripheral (MFP), according to an embodiment of the present disclosure.

FIG. 3 is a block diagram illustrating a functional configuration of an IoT device according to an embodiment of the present disclosure.

FIG. 4 is a block diagram illustrating an alternative functional configuration of an IoT device according to an embodiment of the present disclosure.

FIG. 5 is a block diagram illustrating a functional configuration of a personal computer (PC) according to an embodiment of the present disclosure.

FIG. 6A to FIG. 6D are tables each illustrating examples of rules stored in a rule storage unit, according to an embodiment of the present disclosure.

FIG. 7 is a conceptual diagram illustrating an example of a rule setup screen, according to an embodiment of the present disclosure.

FIG. 8 is a conceptual diagram illustrating an example of a rule setup screen, according to an embodiment of the present disclosure.

FIG. 9 is a conceptual diagram illustrating an example of a rule setup screen, according to an embodiment of the present disclosure.

FIG. 10 is a conceptual diagram illustrating an example of a rule setup screen, according to an embodiment of the present disclosure.

FIG. 11 is a conceptual diagram illustrating an example of a rule setup screen, according to an embodiment of the present disclosure.

FIG. 12 is a conceptual diagram illustrating an example of a rule setup screen, according to an embodiment of the present disclosure.

FIG. 13 is a flowchart of interactive operation executed by an IoT device, according to an embodiment of the present disclosure.

FIG. 14 is a sequence chart illustrating interactive operation executed by an information processing system according to an embodiment of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

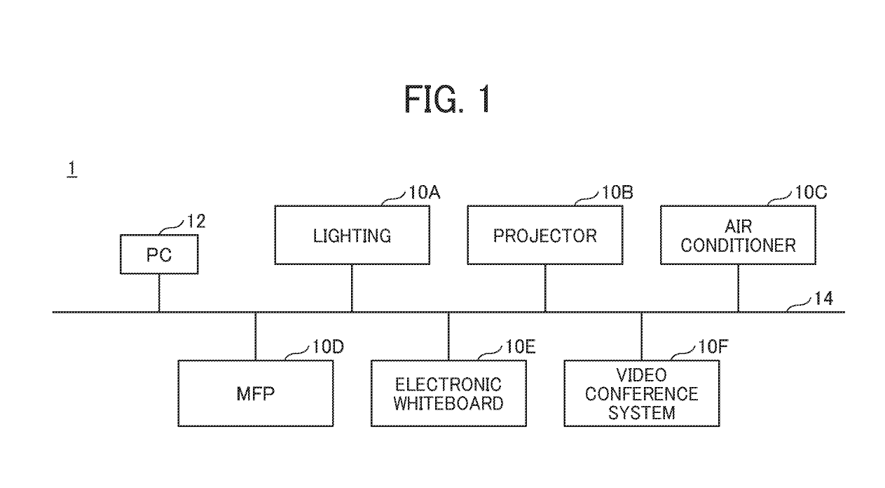

FIG. 1 is a block diagram of an information processing system 1 according to an embodiment of the present disclosure. In FIG. 1, the information processing system 1 includes one or more IoT devices 10 and a PC 12, which are communicably connected to each other via a network 14. The information processing system 1 as illustrated in FIG. 1 includes a lighting 10A, a projector 10B, an air conditioner 10C, an MFP 10D, an electronic whiteboard 10E, and a video conference system 10F as examples of one or more IoT devices 10. The IoT device 10 can be any other kinds of devices that are connectable via the network 14, in addition to the IoT devices 10 as illustrated in FIG. 1. For the sake of explanatory convenience of the embodiments of the present disclosure, each of these devices is referred to, but not limited to, as an “IoT device”.

The network 14 is a segment of network such as a subnetwork, where data can be transmitted by a broadcast transmission. The data that is broadcasted by one of the IoT devices 10 connected to the network 14 reaches all the IoT devices 10 and the PC 12 connected to the network 14 and is not transmitted to other networks connected, for example, via a router. As described above, the subnetwork is an example of a predetermined management unit of network.

In response to detection of an event indicating specific operation such as power-on of the IoT device, which may be referred to as interactive operation, the IoT device 10 broadcasts information related to such detected event of the IoT device, as interaction information. The IoT device 10 executes interactive operation as defined by interaction information according to a predetermined rule in response to reception of the interaction information broadcasted from the other IoT devices 10. A detailed description of the rule will be given later.

The interactive operation is not limited to the interactive operation which causes the other IoT devices 10 to execute the interactive operation, such as an event giving an instruction to the other IoT devices 10 or an event requesting responses from the other IoT devices 10. The interaction information is broadcasted to the other IoT device 10 for simple operation such as power-on or autonomous operation.

The PC 12 is an example of the information processing apparatus that allows a user to set up the rule and transmits the rule to the IoT device 10 to which the rule is to be applied. The rule can be set up using the IoT device 10 such as the MFP 10D which has a user interface (UI). For example, the PC 12 or the IoT device 10 that has a UI may obtain functional information of the IoT device 10 that is connected to the network 14 and may allow the user to set up the rule considering the functions of the IoT device 10. Note that the IoT device 10 in FIG. 1 is an example, and the IoT device 10 can be a laser printer, industrial or home equipment having a communication capability, or medical equipment having a communication capability.

The IoT device 10 broadcasts the interaction information unconditionally to the other IoT devices 10 when the interactive operation occurs. Each one of the other IoT devices 10 connected to the same network 14 determines whether to execute interactive operation in response to the interaction information in accordance with the rule as will be described later.

As described above, in the information processing system 1 according to the present embodiment, interactive operation (such as an event) that occurred in one IoT device 10 causes the other IoT device 10 connected to the same network 14 to execute interactive operation according to interaction information transmitted from the one IoT device 10.

The term IoT device in the present embodiment refers to the device connected to the network 14 to implement the Internet of Things (IoT). In the present embodiment, the lighting 10A, the projector 10B, the air conditioner 10C, the MFP 10D, the electronic whiteboard 10E, and the video conference system 10 OF, are referred to as the examples of the IoT device 10, but the IoT device 10 is not limited to these examples and includes various devices such as a refrigerator, a television set, or a vending machine.

<Hardware Configuration>

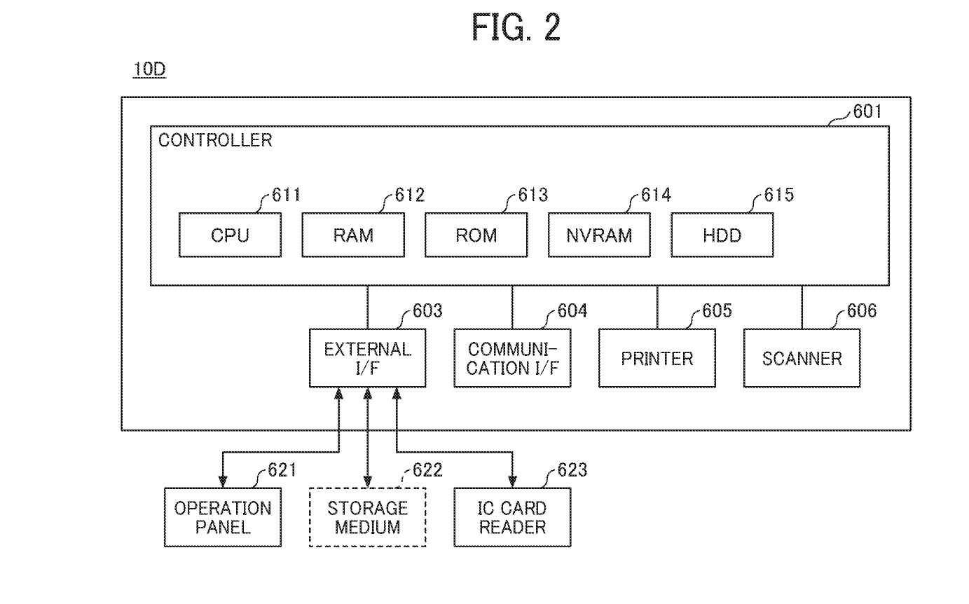

The IoT device 10 in FIG. 1 is implemented by a hardware configuration as illustrated in FIG. 2, for example, when the IoT device 10 is the MFP. FIG. 2 is a block diagram illustrating a hardware configuration of the MFP. As illustrated in FIG. 2, the MFP 10D includes a controller 601, an external interface (I/F) 603, a communication interface (I/F) 604, a printer 605, and a scanner 606.

The controller 601 includes a central processing unit (CPU) 611, a random access memory (RAM) 612, a read only memory (ROM) 613, a non-volatile random access memory (NVRAM) 614, and a hard disk drive (HDD) 615. The ROM 613 stores various programs and data. The RAM 612 stores programs and data temporarily. The NVRAM 614 stores data such as setting information. The HDD 615 stores various programs and data.

The CPU 611 implements the controls or functions of the entirety of the MFP 10D by performing processing according to the programs, data, setting information or the like that are read from a storage device such as the ROM 613, the NVRAM 614, and the HDD 615, and loaded into the RAM 612.

The external I/F 603 is an interface device with an external device. Examples of the external device include the operation panel 621, the storage medium 622, and the IC card reader 623. The MFP 10D communicates with the operation panel 621 and the IC card reader 623 via the external I/F 603. The operation panel 621 includes an input device that accepts input from a user, and a display that displays various types of information.

The MFP 10D reads or writes data from or to the storage medium 622 via external I/F 603. Examples of the storage medium 622 include an integrated circuit (IC) card, a floppy disk, a compact disk (CD), a digital versatile disk (DVD), a secure digital (SD) memory card, a universal serial bus (USB) memory, and a subscriber identification module (SIM) card.

The communication I/F 604 is an interface device to connect the MFP 10D to the network 14. The MFP 10D performs data communication via the communication I/F 604.

The printer 605 is a printing device that forms an image on an object to be conveyed in accordance with print data. Examples of the conveyed medium include paper, coated paper, thick paper, overhead projector (OHP) transparencies, plastic films, prepreg, and copper foil. The scanner 606 is a reading device that scans a document to obtain image data (electronic data).

<Functional Configuration>

The functional configuration of the information processing system 1 according to the present embodiment is explained below. A description of functional configuration that is not relevant to the present embodiment is omitted below as appropriate.

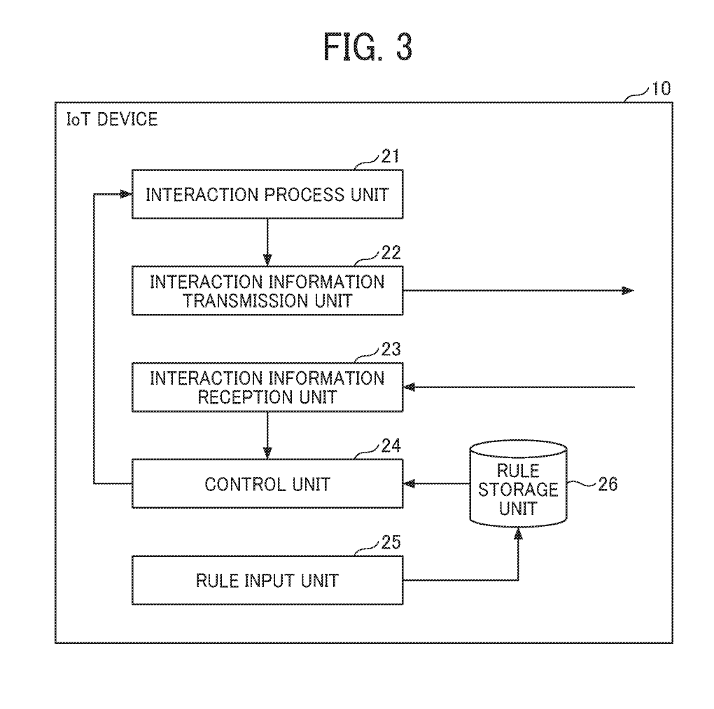

The IoT device 10 according to the present embodiment is implemented by functional blocks as illustrated in FIG. 3. FIG. 3 is a block diagram illustrating a functional configuration of the IoT device 10 according to the present embodiment.

The IoT device 10 of FIG. 3 implements an interaction process unit 21, an interaction information transmission unit 22, an interaction information reception unit 23, a control unit 24, a rule input unit 25, and a rule storage unit 26 by executing a program.

The interaction process unit 21 executes interactive operation (i.e., the event) of the IoT device 10. For example, the interaction process unit 21 of the lighting 10A executes interactive operation such as “turn the lighting on with 50% brightness”. For another example, the interaction process unit 21 of the air conditioner 10C executes interactive operation such as “turn up the air conditioner”.

The interaction information transmission unit 22 broadcasts the interaction information relevant to the interactive operation executed by the interaction process unit 21.

A detailed description is given later of the interaction information. The interaction information reception unit 23 receives the interaction information broadcasted by the other IoT devices 10.

In response to reception of the interaction information from the interaction information reception unit 23, the control unit 24 refers to the rules stored in the rule storage unit 26 and when any rule that matches the received interaction information is found in the stored rules, executes the interactive operation according to the rule. A detailed description of the rule will be given later. A detailed description of the processes of the control unit 24 will be given later. The rule input unit 25 allows the user to set up and store the rule in the rule storage unit 26. For example, the rule input unit 25 displays a rule setup screen to the user and allows the user to input a new rule via the rule setup screen.

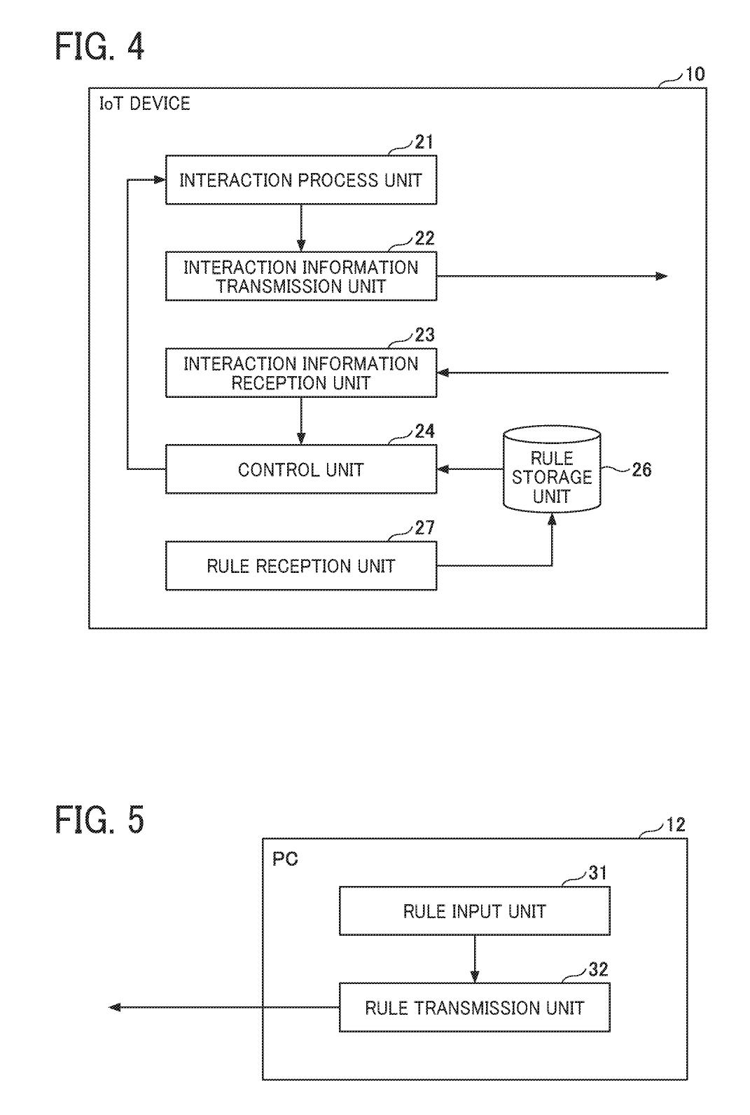

The IoT device 10 in FIG. 3 is an example of the IoT device without a user interface (UI). FIG. 4 is a block diagram illustrating an alternative functional configuration of the IoT device 10 without the UI. FIG. 4 is a block diagram illustrating an alternative functional configuration of the IoT device according to the present embodiment. The rule input unit 25 included in the configuration of the IoT device 10 illustrated in FIG. 3 is replaced with a rule reception unit 27 in the configuration of the IoT device 10 illustrated in FIG. 4. The rule reception unit 27 receives the rule transmitted by the PC 12 and stores the rule in the rule storage unit 26.

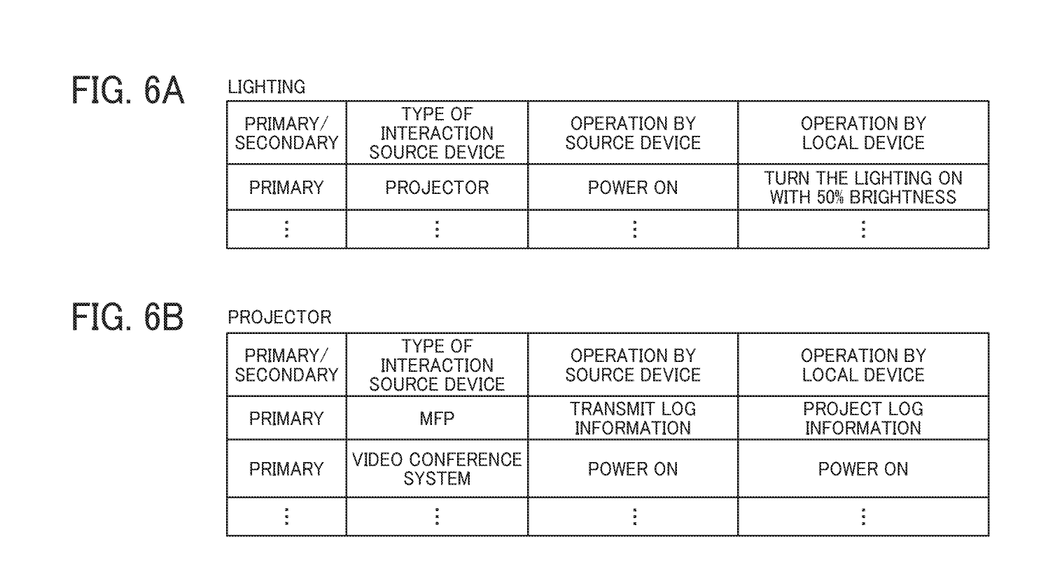

FIG. 5 is a block diagram illustrating a functional configuration of the PC according to the present embodiment. The PC 12 of FIG. 5 implements a rule input unit 31 and a rule transmission unit 32 by executing a program. For example, the rule input unit 31 displays a rule setup screen to the user and allows the user to input a new rule via the rule setup screen. The rule transmission unit 32 transmits the rule that the rule input unit 31 accepted from the user to the target IoT device 10.

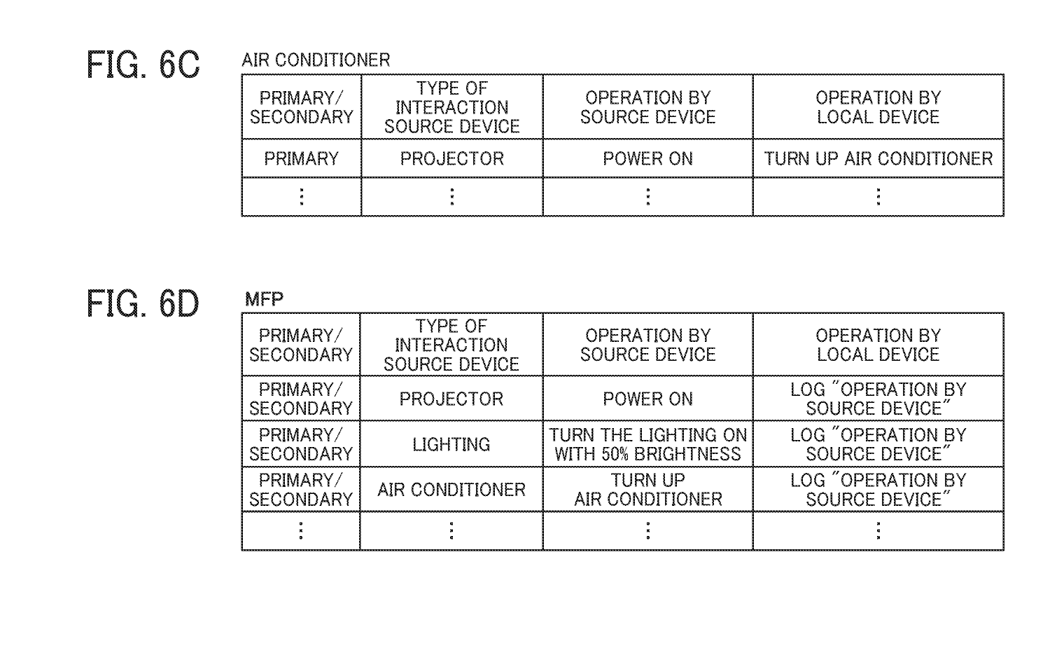

FIG. 6A to FIG. 6D are tables illustrating examples of the rules stored in the rule storage unit. The rules that are illustrated in FIG. 6A to FIG. 6D include items such as the information indicating whether the interaction information is primary interaction information or secondary interaction information, the type of the interaction source device, the interactive operation executed by the source device, and the interactive operation to be executed by the local device.

The term “primary or secondary” indicates whether the interaction information is the primary interaction information or the secondary interaction information. The “primary interaction information” indicates that the interaction information is of the primary interactive operation which is the interactive operation executed without receiving the interaction information from the other IoT device 10. The “secondary interaction information” indicates that the interaction information is of the secondary interactive operation which is the interactive operation executed by receiving the interaction information from the other IoT device 10.

The term “type of the interaction source device” indicates the type of IoT device 10 that transmitted the interaction information. The term “operation by the source device” indicates the interactive operation executed by the IoT device 10 that transmitted the interaction information. The term “operation by the local device” indicates the interactive operation to be performed by the IoT device itself, according to whether the received interaction information is primary or secondary, the type of the interaction source device, and the interactive operation executed by the source device.

FIG. 6A is a table illustrating examples of the rules stored in the rule storage unit 26 of the lighting 10A, according to the present embodiment. FIG. 6B is a table illustrating examples of the rules stored in the rule storage unit 26 of the projector 10B, according to the present embodiment. FIG. 6C is a table illustrating examples of the rules stored in the rule storage unit 26 of the air conditioner 10C, according to the present embodiment. FIG. 6D is a table illustrating examples of the rules stored in the rule storage unit 26 of the MFP 10D, according to the present embodiment.

For example, FIG. 6A describes the rule that the lighting 10A is to be turned on with 50% brightness in response to the primary interaction information broadcasted by the projector 10B indicating that the projector 10B is turned on. FIG. 6B describes the rule that the projector 10B projects the log information in response to the primary interaction information broadcasted by the MFP 10D indicating that the log information is transmitted. Also, FIG. 6B describes the rule that the projector 10B is to be turned on in response to the primary interaction information broadcasted by the video conference system 10F to indicate that the video conference system is turned on. FIG. 6C describes the rule that the air conditioner 10C turns up in response to the primary interaction information broadcasted by the projector 10B to indicate that the projector 10B is turned on.

FIG. 6D describes the rule that the MFP 10D logs the power-on of the projector 10B in response to the primary or secondary interaction information broadcasted by the projector 10B indicating that the projector 10B is turned on. FIG. 6D describes the rule that the MFP 10D logs the power on with 50% brightness of the lighting 10A, in response to the primary or secondary interaction information broadcasted by the lighting 10A indicating that the lighting 10A is turned on with 50% brightness. Also, FIG. 6D describes the rule that the MFP 10D logs the turn up of the air conditioner 10C, in response to the primary or secondary interaction information broadcasted by the air conditioner 10C indicating that the air conditioner 10C is turned up.

Note that the rule with the same type of the interaction source device and the same interactive operation by the source device can be set up, when the interaction information is primary or secondary is different, or when the operation by the local device is different, although example is not given in FIG. 6A to FIG. 6D.

<Operation>

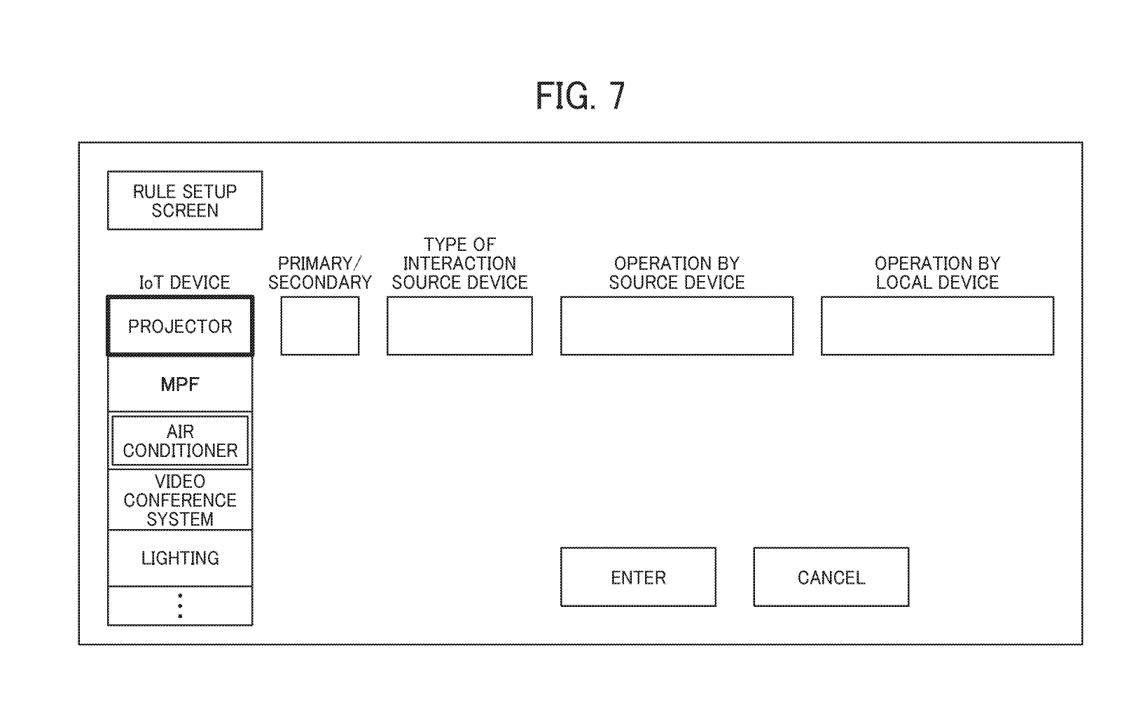

The information processing system 1 according to the present embodiment displays on the IoT device 10 equipped with the UI such as the MFP 10D or the PC 12, the rule setup screen such as illustrated in FIG. 7 to FIG. 12 to allow the user to set up the rule. FIG. 7 to FIG. 12 are the conceptual diagrams illustrating an example of the rule setup screen.

FIG. 7 illustrates how the target IoT device 10 for which a rule is to be set up is selected on the rule setup screen, according to the present embodiment. FIG. 7 illustrates an example where the projector as an IoT device 10 is selected from a list of selectable devices on the rule setup screen, but other selection methods may be used. The selectable IoT devices 10 may be determined based on information collected from the IoT devices 10 connected to the network 14 using the broadcast transmission.

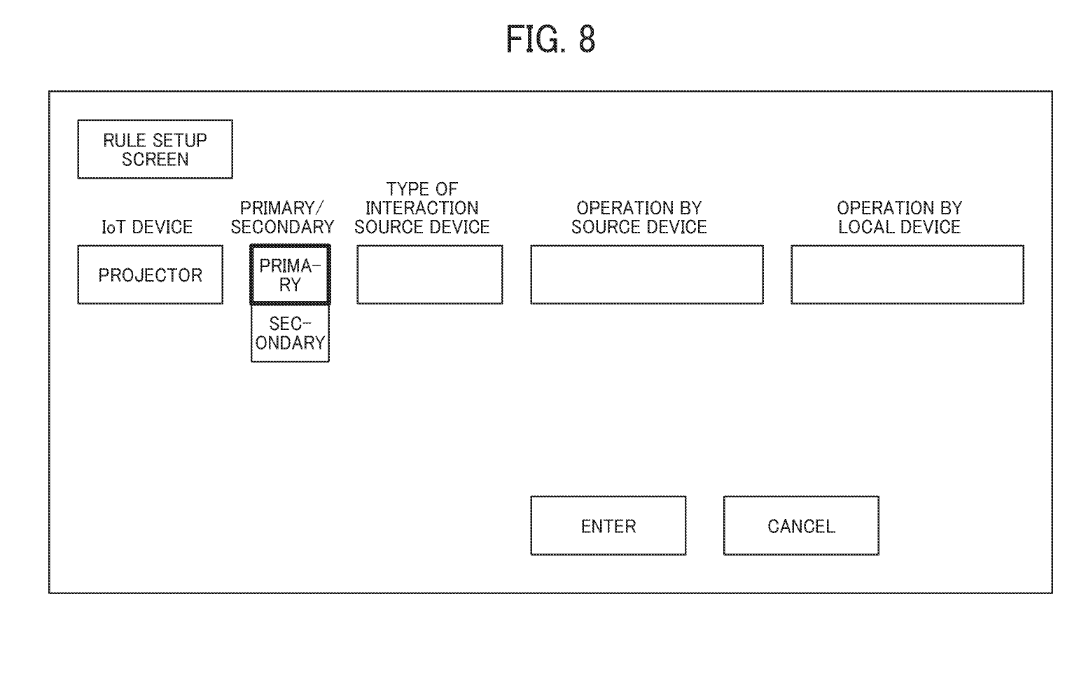

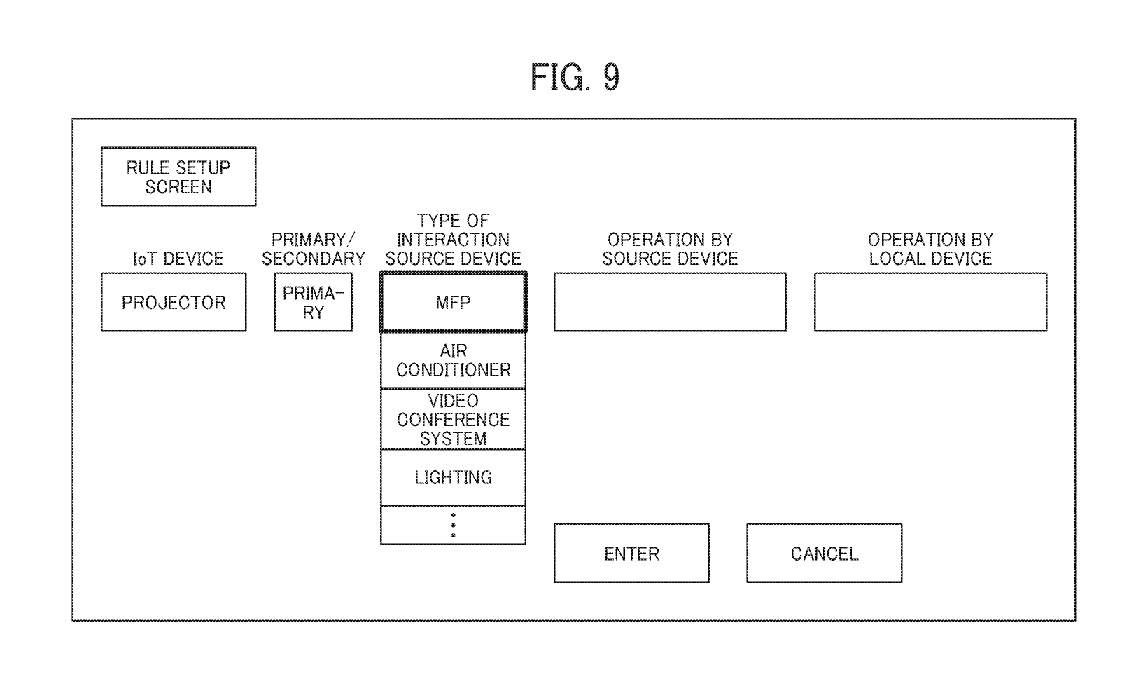

FIG. 8 describes the selection of the primary interaction information or the secondary interaction information on the rule setup screen, according to the present embodiment. FIG. 9 describes the selection of the type of interaction source device on the rule setup screen, according to the present embodiment. FIG. 9 describes the example of selecting the MFP as the type of interaction source device from a list of selectable IoT devices 10 on the rule setup screen, but other selection methods may be used. The selectable IoT devices 10 may be determined based on information collected from the IoT devices 10 connected to the network 14 using the broadcast transmission.

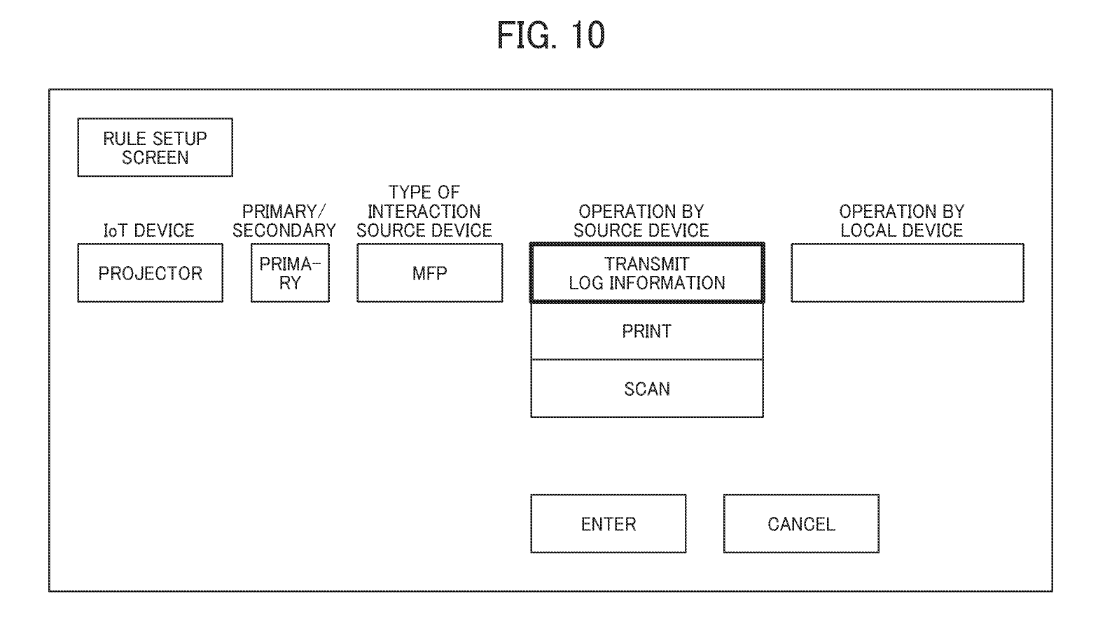

FIG. 10 describes the selection of the interactive operation by the source device on the rule setup screen, according to the present embodiment. FIG. 10 illustrates an example where operation of transmitting log information is selected as the interactive operation of the source device from a list of available operation by the IoT devices 10 on the rule setup screen, but other selection methods may be used. The available operation by the IoT devices 10 may be determined based on information collected from the IoT devices 10 connected to the network 14 using the broadcast transmission.

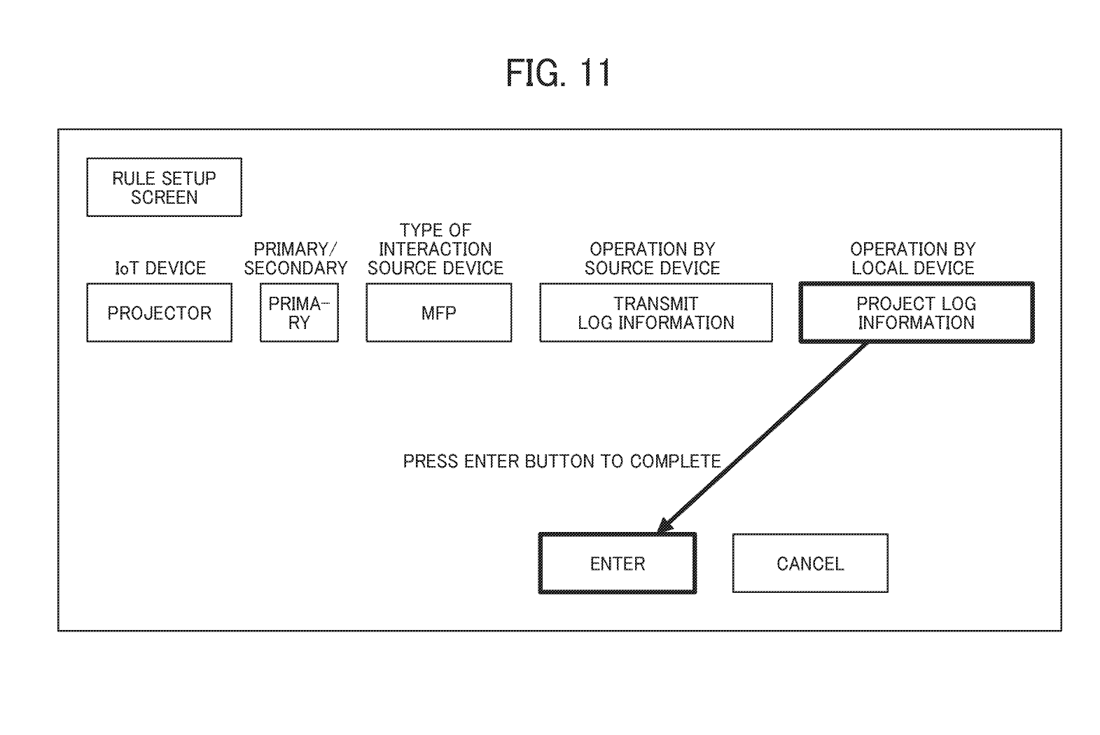

FIG. 11 describes the selection of the project log information as the interactive operation to be executed by the local device on the rule setup screen, according to the present embodiment. The available operation by the local device may be determined based on information collected from the IoT devices 10 connected to the network 14 using the broadcast transmission. When the rule setup screen appears as illustrated in FIG. 11 and the enter button (key) is pressed or touched, the rule input unit 25 or 31 stores the rule set up by the user on the rule setup screen into the rule storage unit 26 of the local IoT device 10.

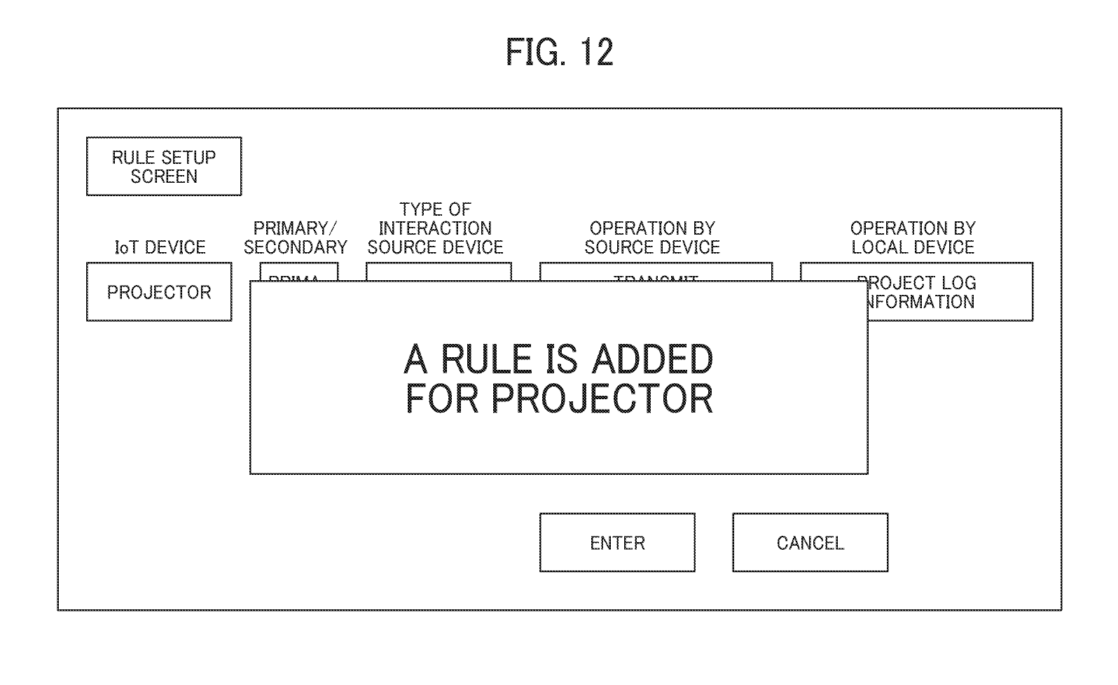

To indicate that the rule is successfully registered, the rule input unit 25 or 31 displays a message on the rule setup screen as illustrated in FIG. 12. The selection of the IoT device 10 on the rule setup screen as illustrated in FIG. 7 to FIG. 12 can be skipped when the rule is added in the rule storage unit 26 of the local IoT device 10 which has the configuration illustrated in FIG. 3.

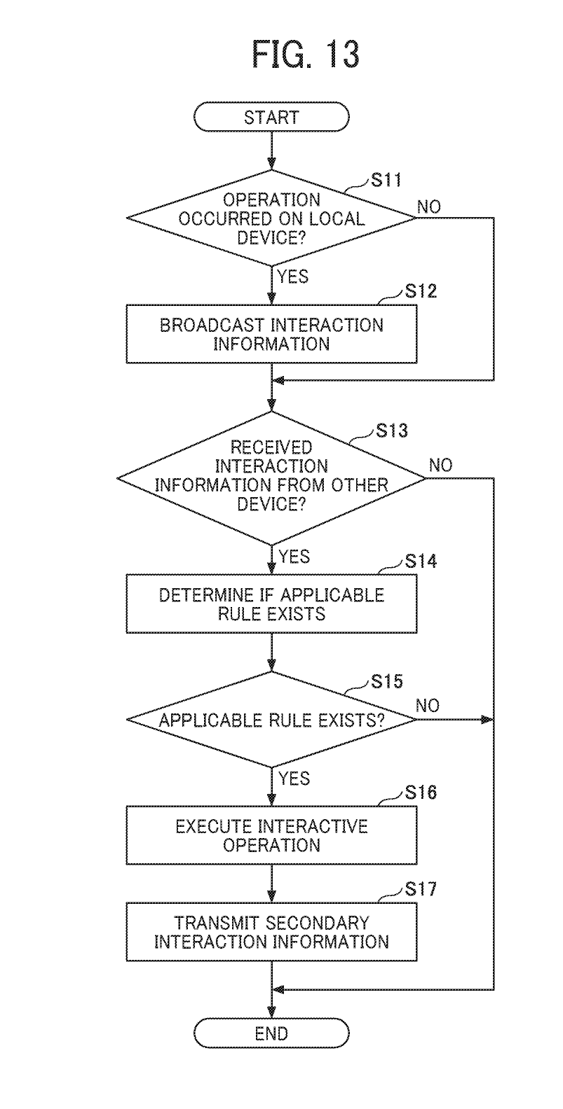

FIG. 13 is a flowchart of the interactive operation of the IoT devices according to the present embodiment. In the step S11, the interaction information transmission unit 22 of the IoT device 10 determines whether any interactive operation has occurred on the local device. In the step S12, the interaction information transmission unit 22 broadcasts the information relevant to the interactive operation executed by the local IoT device 10 in response to the detection of the interactive operation executed by the local IoT device 10. The interaction information broadcasted in the step S12 includes information indicating whether the interaction information is primary or secondary, the type of the local IoT device 10, and the interactive operation executed by the local IoT device 10.

As described above, the IoT device 10 that is connected to the network 14 broadcasts the interactive operation executed by the interaction process unit 21 as the interaction information to the other IoT device 10 connected to the network 14. The interaction information transmission unit 22 skips the step 12 when no operation is detected on the local IoT device 10.

In the step S13, the interaction information reception unit 23 of the IoT device 10 determines whether interaction information is received from the other IoT device 10 using the broadcast transmission. In the step S14, in response to the interaction information from the other IoT device 10 received by the interaction information reception unit 23, the control unit 24 determines whether applicable rule exists.

The step S14 is the process to read the rules stored in the rule storage unit 26 and determine whether the rule applicable to the interaction information that the interaction information reception unit 23 received from the other IoT device 10 exists. The existence of the applicable rule for the interaction information received from the other IoT device 10 is determined by the existence of the rule applicable to the received interaction information in the rule storage unit 26.

When the control unit 24 determines that the applicable rule for the interaction information received from the other IoT device 10 exists in the step S15, the control unit 24 proceeds to the step S16 and controls the local device to execute the interactive operation specified in the rule. The interaction process unit 21 executes the interactive operation by the local device specified in the applicable rule.

In the step 17, the interaction information transmission unit 22 broadcasts the interaction operation performed by the interaction process unit 21 in the step S16 as the secondary interaction information, and then returns to the step 11. The process also returns to the step S11 when the interaction information reception unit 23 does not receive any interaction information from the other IoT device 10 in the step S13 or when no applicable rule is found in the step S15.

As described above, the IoT device 10 that is connected to the network 14 broadcasts the secondary interaction information after executing the interactive operation by the local device as specified in the applicable rule.

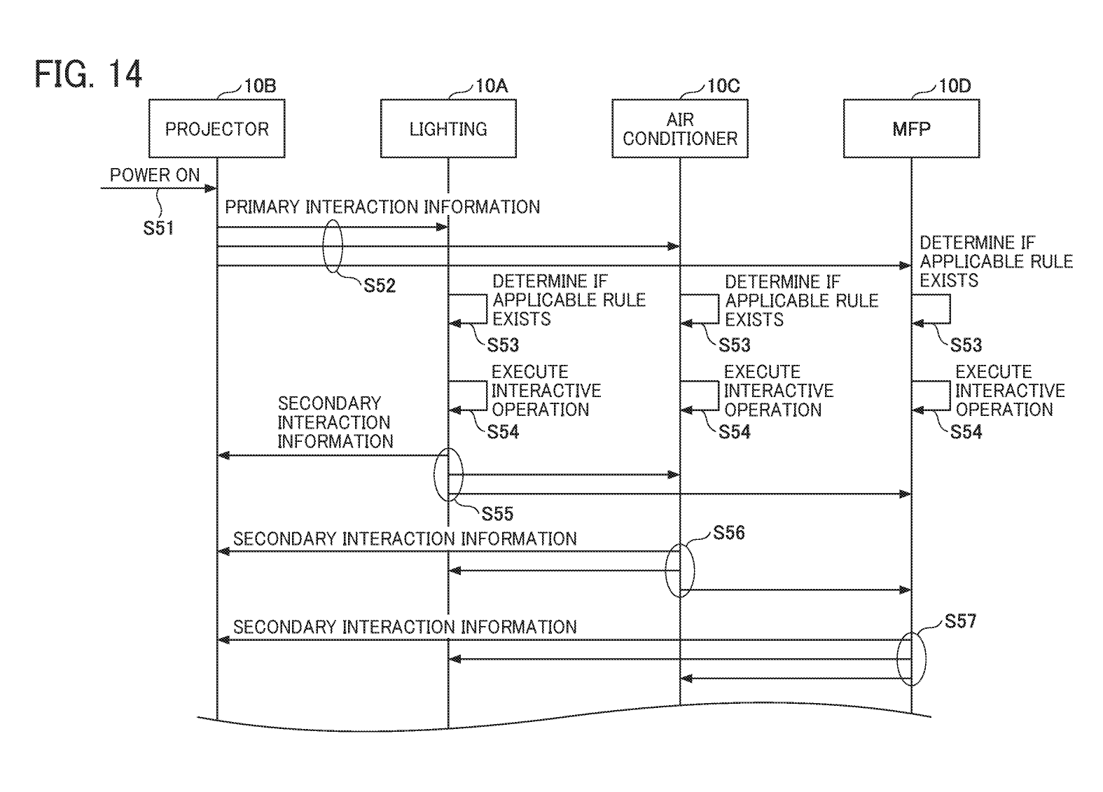

FIG. 14 is a sequence chart illustrating interactive operation processes executed by the information processing system 1 according to the present embodiment. The sequence chart in FIG. 14 illustrates an example where the rules described in FIG. 6A to FIG. 6D are stored in the rule storage units 26 of the lighting 10A, the projector 10B, the air conditioner 10C, and the MFP 10D. The electronic whiteboard 10E and video conference system 10F are omitted.

In the step S51, the projector 10B is turned on by the user. In the step S52, the interaction information transmission unit 22 of the projector 10B broadcasts the primary interaction information. The primary interaction information broadcasted in the step S52 includes the information indicating that the interaction information is the primary information, the information indicating that the interaction information is from the projector, and the information indicating that the projector is turned on.

The lighting 10A, the air conditioner 10C, and the MFP 10D receive the primary interaction information broadcasted from the projector 10B and determine the existence of the applicable rule in the step S53, and execute the interactive operation in the step S54. Note also that the determination of applicable rule in step 53 corresponds to the step S14 in FIG. 13. The step 54 described as “execute interactive operation” corresponds to the step S16 in FIG. 13.

As FIG. 14 illustrates an example where the rules described in FIG. 6A to FIG. 6D are applicable, the rules are determined to be applicable for each one of the lighting 10A, the air conditioner 10C, and the MFP 10D in the step S53, and the interactive operation is executed as in the step S54. The interactive operation in the step 54 is skipped when the applicable rule does not exist.

In the step 55 to the step S57, the lighting 10A, the air conditioner 10C, and the MFP 10D broadcast the interactive operation executed by the interaction process unit 21 in the step S54 as the secondary interaction information. Each of the lighting 10A, the projector 10B, the air conditioner 10C, and the MFP 10D determines the existence of the applicable rule as indicated in the step 53, and executes the interactive operation as described in the step S54 in response to the secondary interaction information.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, a personal digital assistant, a mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, a hard disk, a compact disk read only memory (CD ROM), a magnetic tape device or a solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus.

Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A device connected to at least one other device via a network, the device comprising:
a memory configured to store a rule that associates interaction information related to interactive operation of the at least one other device with interactive operation of a local device to be executed by the local device; and
circuitry configured to:
transmit interaction information related to interactive operation of the local device to the at least one other device via the network in response to occurrence of the interaction operation at the local device;
receive interaction information related to interactive operation of the at least one other device from the at least one other device that has executed the interactive operation via the network; and
based on a determination that a rule for the received interaction information is stored in the memory, execute the interactive operation of the local device that is associated with the received interaction information by the stored rule.

2. The device of claim 1, wherein the received interaction information of the at least one other device includes information on a type of the at least one other device that has executed the interactive operation and information on the interactive operation of the at least one other device.

3. The device of claim 1,
wherein the interaction information transmitted to the other device includes information indicating whether the interaction information is primary interaction information or secondary interaction information,
the primary interaction information indicating that the interactive operation is executed without receiving the interaction information from the at least one other device,
the secondary interaction information indicating that the interactive operation is executed by receiving the interaction information from the at least one other device,
wherein the circuitry of the device is further configured to further store, as the rule, information on whether the interaction information is of the primary interaction information or the secondary interaction information, in association with the interaction information related to the interactive operation of the at least one other device, and the interactive operation of the local device to be executed by the local device.

4. The device of claim 3, wherein the circuitry is configured to allow a user to set up the rule.

5. The device of claim 1, wherein the network which the device is connected to is a subnetwork.

6. The device of claim 1,
wherein the circuitry is configured to transmit the interaction information of the interactive operation executed by the local device to the at least one other device using a broadcast transmission, and to receive the interaction information of the interactive operation executed by the at least one other device transmitted by the broadcast transmission.

7. The device of claim 1, wherein the interaction information exchanged between the devices are related to an event that triggers execution of operation.

8. An information processing system comprising a plurality of devices connected via a network, each device comprising:
a memory configured to store a rule that associates interaction information related to interactive operation of at least one other device with interactive operation of a local device to be executed by the local device; and
circuitry configured to:
transmit interaction information related to interactive operation of the local device to the at least one other device via the network in response to occurrence of the interaction operation at the local device;
receive interaction information related to interactive operation of the at least one other device from the at least one other device that has executed the interactive operation via the network; and
based on a determination that a rule for the received interaction information is stored in the memory, execute the interactive operation of the local device that is associated with the received interaction information by the stored rule

9. A method of controlling interactive operation of a device connected to at least one other device via a network, the method comprising:
storing, in a memory, a rule that associates interaction information related to interactive operation of the at least one other device with interactive operation of a local device to be executed by the local device;
transmitting interaction information related to interactive operation of the local device to the at least one other device via the network in response to occurrence of the interaction operation at the local device;
receiving interaction information related to interactive operation of the at least one other device from the at least one other device that has executed the interactive operation via the network; and
based on a determination that a rule for the received interaction information is stored in the memory, execute the interactive operation of the local device that is associated with the received interaction information by the stored rule.

10. The method of claim 9, wherein the received interaction information of the at least one other device includes information on a type of the at least one other device and the interactive operation of the at least one other device.

11. The method of claim 9, wherein the interaction information transmitted to the at least one other device includes whether the interaction information is primary interaction information which indicates that the interactive operation is executed without receiving the interaction information from the at least one other device or secondary interaction information which indicates that the interactive operation is executed by receiving the interaction information from the at least one other device,
the method further comprising storing a second rule which associates information on whether the interaction information is of the primary interaction information or the secondary interaction information, the interaction information related to the interactive operation of the at least one other device, and the interactive operation of the local device to be executed by the local device.

12. The method of claim 9, further comprising allowing a user to set up the second rule.

13. The method of claim 9, wherein the network to which the device is connected is a subnetwork.

14. The method of claim 9, further comprising:
transmitting the interaction information of the operation executed by the local device to the at least one other device using a broadcast transmission; and
receiving the interaction information of the operation executed by the at least one other device transmitted by the broadcast transmission.

15. The method of claim 9, wherein the interaction information exchanged between the device and the at least one device are related to the interactive operation.
